(19) United States
(12) Patent Application Publication
(10) Pub. No.: US 2023/0279880 A1
(43) Pub. Date: Sep. 7, 2023

(54) Remote-Controlled Wireless Frame

(71) Applicants: ZOOMLION Heavy Industry NA, Inc., Yorkville, WI (US); ZOOMLION Heavy Industry Science and Technology Co. Ltd., Changsha Hunan Province (CN)

(72) Inventors: Mark McKinley, Wauwatosa, WI (US); Brittney Bembenek, Milwaukee, WI (US); Matthew Seeger, Franskville, WI (US)

(21) Appl. No.: 17/686,777

(22) Filed: Mar. 4, 2022

(51) Int. Cl. F15B 21/08; E02F 9/20

(52) U.S. Cl. CPC F15B 21/08; E02F 9/205

(57) ABSTRACT

A remote-control device preferably includes two joysticks, two sliders/thumbwheels, a plurality of three-position toggle switches, a plurality of two-position switches, a plurality of push buttons, an electrical stop button and a rotary knob. The two joysticks are used to control motions of a tool. The two sliders/thumbwheels control two tracks that are used to move and steer the wireless frame. One of the plurality of three-position toggle switches are used to initiate wireless communication with a frame transceiver of the wireless frame. A wireless frame preferably includes a frame member, a frame transceiver, a frame bridge controller and an electro-hydraulic conversion valve. The frame bridge controller receives signals from the remote-control device through the frame transceiver. The frame member preferably includes a frame support, an engine, a hydraulic pump, at least one electrical component and a plurality of hydraulically operated components.

### BACKGROUND OF THE INVENTION

### 1. Field of the Invention

The present invention relates generally to heavy equipment and more specifically to a remote-controlled wireless frame, which is used in conjunction with a remote-control device for remote operation of the remote-controlled wireless frame.

### 2. Discussion of the Prior Art

The remote-controlled wireless frame is located a distance from a remote-control device. The wireless frame may be a remote wireless hydraulic frame or a remote wireless electrical frame. The remote wireless hydraulic frame includes at least one tool, such as a shovel. The remote-control device communicates wirelessly with the remote wireless hydraulic frame. The remote-control device communicates wirelessly with the remote wireless electrical frame. The wireless communication may be implemented with any suitable wireless protocol. U.S. Pat. No. 8,272,467 to Staab discloses a remotely controlled backhoe. U.S. Pat. No. 8,428,791 to Carlsson discloses a control system for a remote control work machine. U.S. Pat. No. 9,213,331 to Johnson et al. discloses a remote control system for a machine.

Accordingly, there is clearly felt need in the art for a remote-controlled wireless frame, which is used in conjunction with a remote-control device for remote operation of the remote-controlled wireless frame; and has a cab member removed from the wireless frame during operation of the remote-control device.

### SUMMARY OF THE INVENTION

The present invention provides a remote-controlled wireless frame, which has a cab member removed from the wireless frame during operation of the remote-control device. The remote-control device preferably includes two joysticks, two sliders/thumbwheels, a plurality of three-position toggle switches, a plurality of two-position switches, a plurality of push buttons, an electrical stop button and a rotary knob. A satisfactory remote-control device may be purchased from Magnetek of Menomonee Falls, Wis. However, other remote-control devices could also be used. The two joysticks are used to control motions of a tool. The two sliders/thumbwheels control two tracks that are used to move and steer the wireless frame. One of the plurality of three-position toggle switches are used to initiate wireless communication with a frame transceiver of the wireless frame. One of the plurality of two-position switches is used to start the internal combustion engine. The rotary knob is used to change an rpm of the internal combustion engine. Another one of the plurality of two-position switches is used to turn-off the internal combustion engine.

A remote wireless hydraulic frame preferably includes a frame member, a frame transceiver, a frame bridge controller and an electro-hydraulic conversion valve. The frame member preferably includes a frame support, an engine, a hydraulic pump, at least one electrical component and at least one tool. The engine, the hydraulic pump, the at least one electrical component and the at least one tool are retained on the frame support. The electro-hydraulic conversion valve preferably includes a valve block, a plurality of proportioning valves, at least two shuttle valves and a frame pilot hydraulic circuit. The valve block includes a plurality of proportioning threaded taps for receiving the plurality of proportioning valves; a high side inlet for receiving pressurized hydraulic fluid for the plurality of proportioning valves from the frame pilot hydraulic circuit; a return outlet for return hydraulic fluid from the plurality of proportioning valves to a tank; and a plurality of supply outlets for supplying various hydraulic components with pressurized hydraulic fluid. A supply passage is formed in the valve block to supply the plurality of proportioning valves with hydraulic fluid from the frame pilot circuit. A return passage is formed in the valve block to receive hydraulic fluid from the plurality of proportioning valves. A supply outlet of each proportioning valve supplies hydraulic pressurized hydraulic to a particular hydraulically operated component. An output pressure of each proportion valve is determined by an electrical signal sent from the remote-control device. The electrical signal from the remote-control device is received by the frame transceiver. The frame bridge controller receives electrical signals from the frame transceiver and converts the signals into a suitable form.

The electrical signals are sent from the frame bridge controller to the electro-hydraulic conversion valve, a hydraulic controller, an engine controller and at least one electrical component. The electrical signals sent to the electro-hydraulic conversion valve operate the plurality of proportioning valves to control the flow of hydraulic fluid to various hydraulically operated components. The hydraulic lines from the electro-hydraulic conversion valve preferably include quick coupling ends for retention in a plurality of hydraulic connectors in a hydraulic bulkhead.

A remote wireless electric frame preferably includes a frame member, a frame transceiver and a frame bridge controller. The frame member preferably includes a frame support, an engine, at least one electrical component, a plurality of hydraulic components and at least one tool. The engine, the at least one electrical component, the plurality of hydraulic components and the at least one tool are retained on the frame support. An electrical signal originates from the remote-control device. The remote-control device wirelessly transmits electrical signals to the frame transceiver. The frame bridge controller receives electrical signals from the frame transceiver and converts the signals into a suitable form. The electrical signals are sent from the frame bridge controller to a hydraulic controller, an engine controller and at least one electrical component. The electrical signals are sent to the hydraulic controller to control a plurality of hydraulic components on the frame support.

Accordingly, it is an object of the present invention to provide a remote-controlled wireless frame, which is used in conjunction with a remote-control device for remote operation of the remote-controlled wireless frame.

Finally, it is another object of the present invention to provide a remote-controlled wireless frame, which has a cab member removed from the wireless frame during operation of the remote-control device.

These and additional objects, advantages, features and benefits of the present invention will become apparent from the following specification.

### BRIEF DESCRIPTION OF THE DRAWINGS

FIG. 1 is a top view of a remote-control device of a remote-controlled wireless frame in accordance with the present invention.

FIG. 2 is a schematic diagram of a remote wireless hydraulic frame in accordance with the present invention.

FIG. 3 is an end perspective view of an electro-hydraulic conversion valve of a remote wireless hydraulic frame in accordance with the present invention.

FIG. 4 is a top perspective view of an electro-hydraulic conversion valve of a remote wireless hydraulic frame in accordance with the present invention.

FIG. 5 is a schematic diagram of an electro-hydraulic conversion valve of a remote wireless hydraulic frame in accordance with the present invention.

FIG. 6 is a schematic diagram of a remote wireless electric frame in accordance with the present invention.

### DETAILED DESCRIPTION OF THE PREFERRED EMBODIMENTS

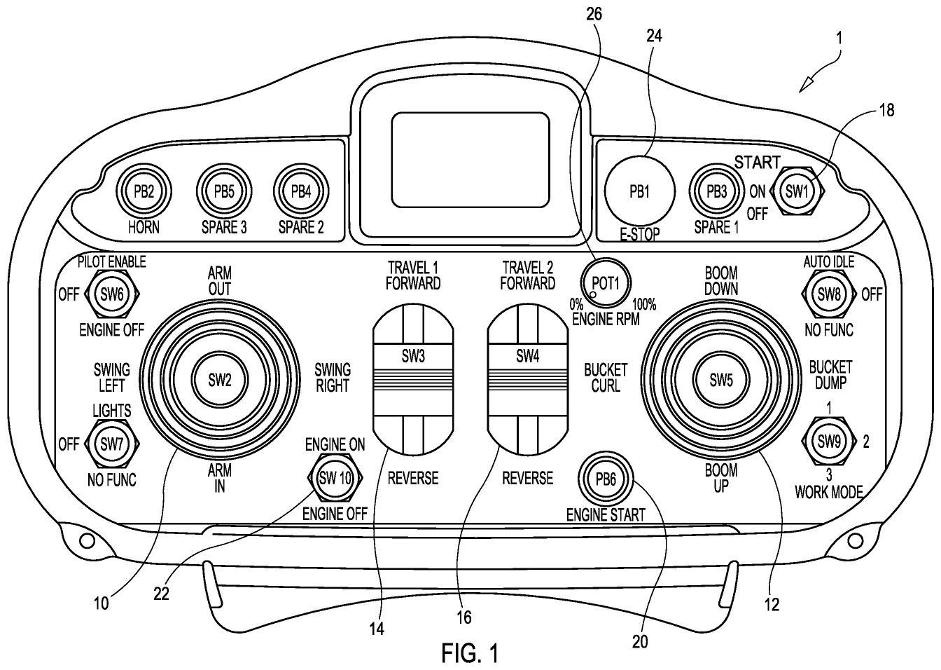

With reference now to the drawings, and particularly to FIG. 1, there is shown a top view of a remote control device 1. The remote-control device 1 preferably includes a first joystick 10, a second joystick 12, a first slider/thumbwheel 14, a second slider thumbwheel 16, a communication three-position toggle switch 18, a start momentary push-button switch 20, an engine two-position toggle switch 22, an electrical stop button switch 24 and a rpm rotary switch 26. The first joystick 10 is preferably used to control the motion of an arm of a boom, and swinging of a boom. The second joystick 12 is preferably used to control vertical motion of the boom, and curl a bucket or dump the bucket. The first slider/thumbwheel 14 is used to control rotation of one of the tracks. The second slider/thumbwheel 16 is used to control rotation of the other track. The communication three-position toggle switch 18 is used to control communication with a frame transceiver 52 of a remote wireless hydraulic frame 2 or a remote wireless electric frame 3. The start momentary push-button switch 20 is used to start an internal combustion engine 80. The engine two-position toggle switch 22 is used to turn the internal combustion engine 80 on or off. The engine two-position toggle switch 22 must be in the “on” position to start the internal combustion engine 80. The electrical stop button switch 24 is used to turn off all electrical components 86. The rotary knob 26 acts as a throttle to control an rpm of the internal combustion engine 80. The remote-control device 1 sends wireless commands to the frame transceiver 52.

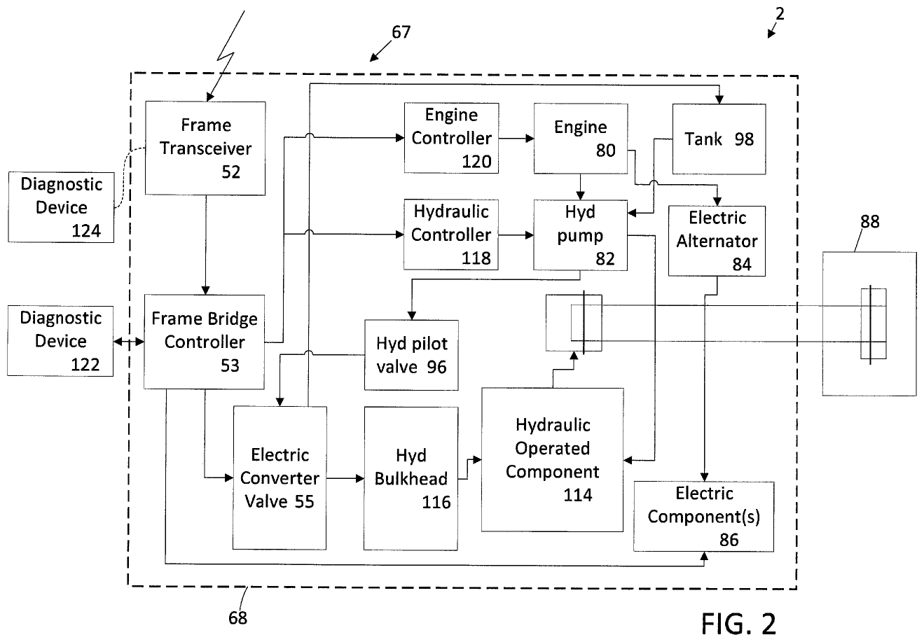

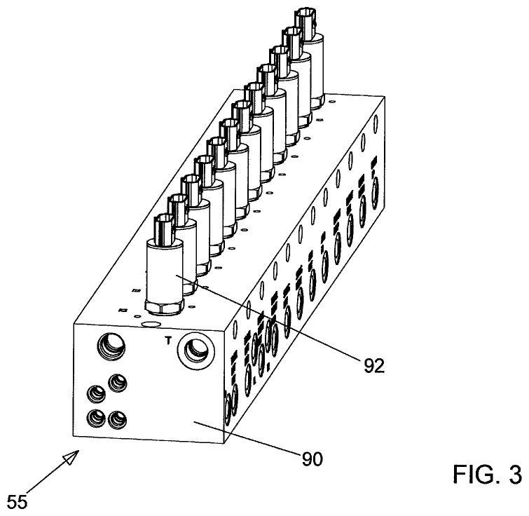

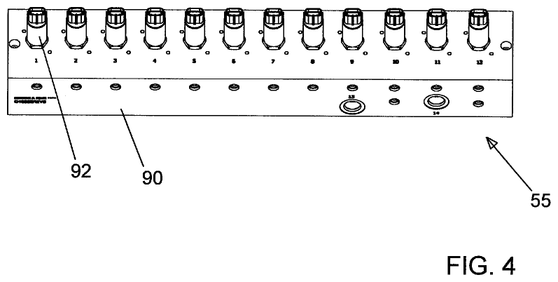

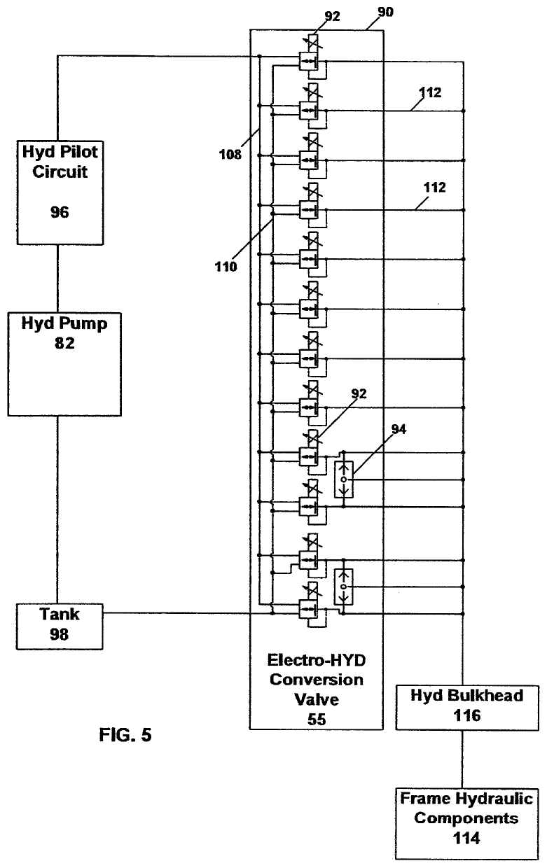

With reference to FIG. 2, the remote wireless hydraulic frame 2 preferably includes a frame member 67, a frame transceiver 52, a frame bridge controller 53 and an electro-hydraulic conversion valve 55. However, the frame bridge controller 53 could be integrated into the frame transceiver 52. The frame member 67 preferably includes a frame support 68, the engine 80, a hydraulic pump 82, an electrical alternator 84, at least one electrical component 86 and at least one tool 88. The engine 80, the hydraulic pump 82, the electrical alternator 84, the at least one electrical component 86 and the at least one tool 88 are retained on the frame support 68. The electrical alternator 84 is driven by the engine 80. With reference to FIGS. 3-5, the electro-hydraulic conversion valve 55 preferably includes a valve block 90, a plurality of proportioning valves 92, at least two shuttle valves 94 and a frame pilot hydraulic circuit 96. The valve block 90 includes a plurality of proportioning threaded taps for receiving the plurality of proportioning valves 92; a high side inlet for receiving pressurized hydraulic fluid for the plurality of proportioning valves 92 from the frame pilot hydraulic circuit 96; a return outlet for returning hydraulic fluid from the plurality of proportioning valves 92 to a tank 98 and a plurality of supply outlets 112 for supplying various hydraulic components with pressurized hydraulic fluid. The shuttle valves 94 send an electrical signal to an alarm device, when the remote wireless hydraulic frame 2 is moving.

A supply passage 108 is formed in the valve block 90 to supply the plurality of proportioning valves 92 with hydraulic fluid from the frame pilot circuit 96. A return passage 110 is formed in the valve block 90 to receive hydraulic fluid from the plurality of proportioning valves 92. The supply outlet 112 of each proportioning valve 92 supplies hydraulic pressurized hydraulic to a particular hydraulically operated component 114 preferably through a hydraulic bulkhead 116. An output pressure of each proportion valve 92 is determined by an electrical signal sent from the frame bridge controller 53.

Electrical signals originate from one of the input control devices 10, 12, 14, 16, 18, 20, 22, 24 and 26 on the remote-control device 1. The frame bridge controller 53 receives the electrical signals from the frame transceiver 52 and converts the signals into a suitable form. The electrical signals are sent from the frame bridge controller 53 to the electro-hydraulic conversion valve 55, a hydraulic controller 118, an engine controller 120 and the at least one electrical component 86. The electrical signals sent to the electro-hydraulic conversion valve 55 operate the plurality of proportioning valves 92 to control the flow of hydraulic fluid to various hydraulically operated components 114. Outlet hydraulic lines 112 from the electro-hydraulic conversion valve 55 preferably include quick coupling ends for retention in a plurality of hydraulic connectors in the hydraulic bulkhead 116. Electrical signals are also sent to the hydraulic controller 118. The electrical signals go to the engine controller 120 or the at least one electrical component 86.

A diagnostic device 122 may be connected to the frame bridge controller 53 through a wired connection to monitor various hydraulic pressures of the hydraulic operated components 114 and status of the hydraulic controller 118, the engine controller 120, and electrical components 86. A wireless diagnostic device 124 may be connected to the frame transceiver 52 through a wireless connection.

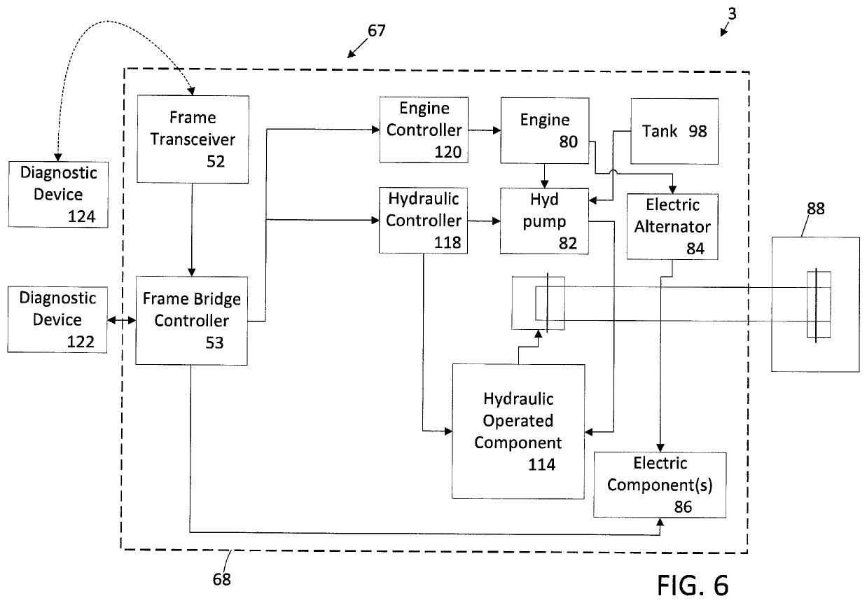

With reference to FIG. 6, the remote wireless electric frame 3 preferably includes the frame member 67, the frame transceiver 52 and the frame bridge controller 53. The frame member 67 preferably includes the frame support 68, the engine 80, the hydraulic pump 82, the electrical alternator 84, the at least one electrical component 86, the at least one tool 88 and the plurality of hydraulically operated components 114. The engine 80, the hydraulic pump 82, the electrical alternator 84, the at least one electrical component 86, the at least one tool 88 and the plurality of hydraulically operated components 114 are retained on the frame support 68. The electrical alternator 84 is driven by the engine 80.

Electrical signals originate from one of the input control devices 10, 12, 14, 16, 18, 20, 22, 24 and 26 on the remote-control device 1. The frame bridge controller 53 receives the electrical signals from the frame transceiver 52 and converts the signals into a suitable form. The electrical signals are sent from the frame bridge controller 53 to the hydraulic controller 118, the engine controller 120 and the at least one electrical component 86. The hydraulic controller 118 controls the flow of hydraulic fluid to various hydraulically operated components 114 and the at least one tool 88, through a plurality of hydraulic valves (not shown).

A diagnostic device 122 may be connected to the frame bridge controller 53 through a wired connection to monitor various hydraulic pressures of the hydraulically operated components 114 and status of the hydraulic controller 118, the engine controller 120, the at least one electrical component 86 and the at least one tool 88. A wireless diagnostic device 124 may be wirelessly connected to the frame bridge controller 53 through the frame transceiver 52.

While particular embodiments of the invention have been shown and described, it will be obvious to those skilled in the art that changes and modifications may be made without departing from the invention in its broader aspects, and therefore, the aim in the appended claims is to cover all such changes and modifications as fall within the true spirit and scope of the invention.

We claim:

1. A remote-controlled wireless hydraulic frame without a cab member attached to the wireless hydraulic frame, comprising:
a remote-control device including a plurality of input control devices for transmitting a plurality of wireless electrical signals;
a frame member;
a frame transceiver receives the plurality of wireless electrical signals from said remote-control device and outputs a plurality of electrical signals; and
an electro-hydraulic conversion valve includes a plurality of proportioning valves, pressurized fluid is supplied to said plurality of proportioning valves, a return passage is connected to said plurality of proportioning valves, a plurality of supply outlets are connected to said plurality of proportioning valves, wherein said plurality of supply outlets are connected to a plurality of hydraulic components on said frame member, said frame transceiver outputs the plurality of electrical signals to said plurality of proportioning valves.

2. The remote-controlled wireless hydraulic frame of claim 1, further comprising:
a wireless diagnostic device communicates with said frame transceiver.

3. The remote-controlled wireless hydraulic frame of claim 1, further comprising:
a diagnostic device is connected to said frame transceiver.

4. The remote-controlled wireless hydraulic frame of claim 1 wherein:
said remote control device is used to control a motion of a machine.

5. A remote-controlled wireless hydraulic frame without a cab member attached to the wireless hydraulic frame, comprising:
a remote-control device including a plurality of input control devices for transmitting a plurality of wireless electrical signals;
a frame member;
a frame transceiver receives the plurality of wireless electrical signals from said remote-control device;
a frame bridge controller receives the plurality of wireless electrical signals from said frame transceiver and outputs a plurality of electrical signals; and
an electro-hydraulic conversion valve includes a valve block and a plurality of proportioning valves, a plurality of threaded taps are formed in the valve block to receive the plurality of proportioning valves, pressurized fluid is supplied to said plurality of proportioning valves through a pressurized pathway in said valve block, a return passage is formed in said valve block and connected to said plurality of proportioning valves, a plurality of supply outlets are connected to said plurality of proportioning valves through said valve block, wherein said supply outlets are connected to a plurality of hydraulic components on said frame member, said frame bridge controller outputs said plurality of electrical signals to said plurality of proportioning valves.

6. The remote-controlled wireless hydraulic frame of claim 5, further comprising:
a wireless diagnostic device communicates with said frame transceiver.

7. The remote-controlled wireless hydraulic frame of claim 5, further comprising:
a diagnostic device is connected to said frame bridge controller.

8. The remote-controlled wireless hydraulic frame of claim 5 wherein:
said remote control device is used to control a motion of a machine.

9. A remote-controlled wireless electric frame without a cab member attached to the wireless electric frame, comprising:
a remote-control device including a plurality of input control devices for transmitting a plurality of wireless electrical signals;
a frame member;
a frame transceiver receives the plurality of wireless electrical signals from said remote-control device, said frame transceiver outputs a plurality of electrical signals to a hydraulic controller, an engine controller and at least one electrical component, said hydraulic controller controls at least one hydraulically operated component on said frame member.

10. The remote wireless electric frame of claim 9, further comprising:
a wireless diagnostic device communicates with said frame transceiver.

11. The remote wireless electric frame of claim 9, further comprising:
a diagnostic device is coupled to said frame transceiver.

12. The remote-controlled wireless hydraulic frame of claim 9 wherein:
said remote control device is used to control a machine.
